(19) United States
(12) Patent Application Publication
(10) Pub. No.: US 2013/0301033 A1
(43) Pub. Date: Nov. 14, 2013

(54) Submicron Resolution Spectral-Domain Optical Coherence Tomography

(71) Applicant: KING ABDULLAH UNIVERSITY OF SCIENCE AND TECHNOLOGY, Thuwal (SA)

(72) Inventors: Erkki Alarousu, Thuwal (SA); Ghassan Jabbour, Thuwal (SA)

(73) Assignee: King Abdullah University of Science and Technology, Thuwal (SA)

(21) Appl. No.: 13/889,720

(22) Filed: May 8, 2013

Related U.S. Application Data
(60) Provisional application No. 61/644,240, filed on May 8, 2012.

(51) Int. Cl. G01J 3/45

(52) U.S. Cl. CPC G01J 3/45
USPC 356/51; 356/456

(57) ABSTRACT

Apparatuses and systems for submicron resolution spectral-domain optical coherence tomography (OCT) are disclosed. The system may use white light sources having wavelengths within 400-1000 nanometers, and achieve resolution below 1 μm. The apparatus is aggregated into a unitary piece, and a user can connect the apparatus to a user provided controller and/or light source. The light source may be a supercontinuum source.

### CROSS-REFERENCE TO RELATED APPLICATIONS

This application claims benefit of priority of U.S. Patent Application No. 61/644,240 to Erkki Alarousu et al. filed on May 8, 2012 and entitled “Submicron Resolution Spectral-Domain Optical Coherence Tomography,” which is hereby incorporated by reference in its entirety.

### BACKGROUND OF THE INVENTION

1. Field of the Invention

This invention relates to optical coherence tomography and more particularly relates to apparatuses and systems for submicron resolution spectral-domain optical coherence tomography using supercontinuum sources.

2. Description of the Related Art

Optical Coherence Tomography (OCT) is a well-known imaging technique in biomedicine capable of optical sectioning of semi-transparent tissues. OCT, which is based on white-light interferometry, is mostly applied in ophthalmology because of its great power in non-invasive retinal and macular imaging.

OCT is a cross-sectional imaging method offering complete three-dimensional structural reconstruction of an analyzed object. One individual depth scan is referred as an A-scan, which can be treated as an integral over depth dependent reflectivity of the object under measurement. Most common imaging method is B-scan imaging, where several A-scans are combined together to form a cross-sectional image of the object structure called a tomogram. In addition to cross-sectional imaging, OCT is capable of revealing the whole 3D structure of the sample by volume reconstruction.

A major advantage of OCT over many other imaging techniques is its ability to measure not only almost arbitrary size sample quantitative 3D surface topography but internal 3D volumetric data as well; both at the same time. Very few methods are capable of doing this including: Fluorescence Microscopy, X-ray Tomography, and Electron tomography.

Fluorescence Microscopy, i.e. Confocal Laser Scanning Microscopy (CLSM) and Multiphoton Microscopy (MP), are possible candidates but are limited by the fact that they are based on fluorescence and labeling which complicates the measurement of multimaterial samples like solar cells. Fluorescence Microscopy is used mainly for surface/sub-surface imaging and is limited to thin cross-sections (typically a few μm).

X-ray Tomography, i.e. Micro Computed Tomography (μCT), exploits X-rays and enables imaging of optically non-transparent objects, but has a drawback of using harmful X-rays, rather slow measurement speed due to angular imaging sequence, invasive sample preparation, and extensive image processing procedure. X-ray Tomography is best suitable for imaging of metal contacts when considering multilayer structures like solar cells.

Electron tomography, i.e. 3D Transmission Electron Microscopy (3D-TEM), uses electron beams to image ultrathin objects with sub-nanometer resolution—it gives a superior resolution over all techniques presented here but has drawbacks like limited sample thickness (typically few hundred nanometers), extensive and complicated sample preparation and angular imaging sequence.

OCT may be implemented in time-domain or spectral-domain. However, time-domain OCT systems have moving parts which limit the speed of the systems. Spectral-domain OCT systems eliminates the requirement to have moving parts in their reference arms, and higher system speed can be achieved. However, achieving ultra-high resolution (such as submicron resolution) remains a challenge for spectral-domain OCT systems. Further, broadband scanning is another challenge for spectral-domain OCT systems.

### SUMMARY OF THE INVENTION

Embodiments of apparatuses and systems for submicron resolution spectral-domain optical coherence tomography (OCT) are presented. The apparatuses and systems may use white light sources having wavelengths of 1000 nanometers or less. The apparatus for submicron resolution spectral-domain OCT is aggregated into a unitary piece, and a user can connect the apparatus to a user provided controller and/or light source. The light source may be a supercontinuum source.

In one embodiment, the apparatus comprises a sample arm configured to direct a first light beam to a sample and output a sample output beam; a reference arm configured to receive a second light beam and output a reference output beam; a mechanism to combine the sample output beam and the reference output beam to generate a light output; and a spectrometer configured to convert the light output into electrical signals. The first light beam and the second light beam may have wavelengths within a range of 1000 nanometers (nm) or less. In another embodiment, the first light beam and the second light beam may have wavelengths within a range of 400-1000 nanometers.

In one embodiment, the apparatus further comprises a beam splitter configured to split a light input into the first light beam and the second light beam. The light input may be from a light source such as a supercontinuum source or the like. In one embodiment, the light input may have wavelengths only in the range of 400-1000 nanometers. In another embodiment, the light input comprises a first light component having wavelengths within the range of 400-1000 nanometers and a second light component having wavelengths outside the range of 400-1000 nanometers. In such an embodiment, the apparatus further comprises a spectrum shaping device configured to filter out light within the range of 400-1000 nanometers from the light input, and generate a light beam having wavelengths within the range of 400-1000 nanometers.

The sample arm of the apparatus may comprise a focusing device configured to adjust a diameter of the first light beam before the first light beam reaches the sample. The focusing device may be movable along a longitudinal axis of the first light beam. The sample arm may further comprise a stage configured to receive the sample, where the stage may be movable along a longitudinal axis of the first light beam.

In one embodiment, the spectrometer of the apparatus comprises a diffraction grating configured to split the light output into a plurality of light components having different wavelengths. The spectrometer may further comprise a recording device configured to record the plurality of light components as electrical signals. The recording device may be camera, such as a CCD (charge-coupled device) camera, a CMOS (complementary-symmetry metal-oxide-semiconductor) camera, or the like. The spectrometer may also comprise a focusing device (such as a camera objective) configured to adjust the diameter of the light output by the diffraction grating.

In one embodiment, the mechanism to combine the sample output beam and the reference output beam to generate a light output may comprise one or more reflectors, such as mirrors, splitters, and/or combiners. The reflectors may be configured to change the direction of light beams traveling in the apparatus. The splitter may be configured to split a light beam into two or more light beams. The combiner may be configured to combine two or more light beams into a single light beam.

In one embodiment, the apparatus may further comprise one or more mechanisms to adjust (e.g. to attenuate or amplify) density of a light beam. Density of a light beam can be adjusted by passing the light beam through one or more attenuators, such as neutral density filters (ND-filters), polarizer-analyzer-combinations, or the like, or by partially reflecting the light beam from an optical surface.

Systems for submicron resolution spectral-domain OCT are disclosed. In one embodiment, the system comprises a light source configured to output a light input; an apparatus configured to convert a light input into electrical signals; and a controller coupled to the apparatus and configured to receive the electrical signals.

In one embodiment, the apparatus of the system may be an apparatus described above, where the apparatus comprises a sample arm configured to direct a first light beam to a sample and output a sample output beam; a reference arm configured to receive a second light beam and output a reference output beam; a mechanism to combine the sample output beam and the reference output beam to generate a light output; and a spectrometer configured to convert the light output into electrical signals.

In one embodiment, the light source may be a supercontinuum source. The light source may be configured to output a light having wavelengths only within the range of 400-1000 nanometers or 1000 nanometers or less. Alternatively, the light source may be configured to output a light comprising a first light component having wavelengths within a range of 400-1000 nanometers and a second light component having wavelengths outside the range of 400-1000 nanometers. In such an embodiment, the system further comprises a spectrum shaping device configured to filter out light within the range of 400-1000 nanometers from the light input, and generate a light beam having wavelengths within the range of 400-1000 nanometers.

In one embodiment, the apparatus is aggregated into a unitary piece. The apparatus may be detachable from the light source and controller.

The controller of the system may be configured to control the movement of a focusing device which is movable along a longitudinal axis of a light beam, the movement of a stage configured to receive the sample, where the stage is movable along a longitudinal axis of the first light beam, the recording of a light beam as electrical signals by a recording device, and/or storage of the electrical signals. The recording device may be a camera or the like.

The term “coupled” is defined as connected, although not necessarily directly, and not necessarily mechanically. The terms “a” and “an” are defined as one or more unless this disclosure explicitly requires otherwise.

The term “substantially” and its variations are defined as being largely but not necessarily wholly what is specified as understood by one of ordinary skill in the art, and in one non-limiting embodiment “substantially” refers to ranges within 10%, preferably within 5%, more preferably within 1%, and most preferably within 0.5% of what is specified.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

The foregoing has outlined rather broadly the features and technical advantages of the present invention in order that the detailed description that follows may be better understood. Additional features and advantages will be described hereinafter, which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of embodiments of the present invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the embodiments of the present application.

### BRIEF DESCRIPTION OF THE DRAWINGS

For a more complete understanding of the present application, reference is now made to the following descriptions taken in conjunction with the accompanying drawings.

FIG. 1 is a block diagram illustrating one embodiment of a system for submicron resolution spectral-domain optical coherence tomography (OCT), according to certain aspects of the present disclosure.

FIG. 2 is a block diagram illustrating one embodiment of a sample arm for a system for submicron resolution spectral-domain OCT, according to certain aspects of the present disclosure.

FIG. 3 is a block diagram illustrating one embodiment of a spectrometer for a system for submicron resolution spectral-domain OCT, according to certain aspects of the present disclosure.

### DETAILED DESCRIPTION

Various features and advantageous details are explained more fully with reference to the nonlimiting embodiments that are illustrated in the accompanying drawings and detailed in the following description. Descriptions of well known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those having ordinary skill in the art from this disclosure.

### Background

An OCT measurement system usually consists of a Michelson interferometer illuminated by a low-coherent light source, like a supercontinuum source, or a superluminescent diode (SLD) operating at near infrared (NIR) region. Coherence length defines the depth resolution of the OCT system: the broader the spectrum the better the depth resolution. It is beneficial to use ultra-violet-visible wavelengths due to the fact that the best resolution is achieved in that range. A supercontinuum source is an ideal source as it emits light from 400-2000 nanometers (nm), and submicron depth resolution can be achieved.

In addition to width of the spectrum, the shape of the spectrum is also important: the more complex the spectrum, the more complex the autocorrelation function of the interferometer, which lowers the quality of the acquired images and causes false interpretation of scattering sites inside the sample due to side lobes in the autocorrelation function. However, depth and transversal resolutions are not linked to each other. Depth resolution is defined solely by the light source and transversal resolution by the optics thus being limited by diffraction like in conventional microscopy.

In an OCT system, a sample to be investigated is placed in one arm of the interferometer: the measurement i.e. sample arm. The light beam is reflected or scattered from the sample depending on the various optical properties of the material layers in the sample. In time-domain systems, the longitudinal profile of reflectivity versus depth (A-scan) is obtained by translating the mirror in the reference arm and synchronously recording the interfering beams at the output of the interferometer. A fringe pattern is evident at the detector only when the optical path length difference in the interferometer arms is less than the coherence length of the light source. Mirror translation is also used to shift the signal to a certain Doppler frequency to enable removal of noise outside the pass band caused by environmental disturbances, light source fluctuations, vibrations on the system, etc.

In spectral-domain systems, interfering beams are guided to a diffraction grating which diffracts the beam via objective to CCD or CMOS line scan camera. No reference arm translation is needed; reflectivity versus depth (A-scan) is obtained by Fourier transforming the spectral interference. Diffraction grating coupled to a line scan camera forms a spectrometer which measures the spectrum of light equidistant in λ-space. However, depth dependent reflectivity is obtained via discrete Fourier transform in k-space (k=2π/λ, nonlinear relation) that means a linear interpolation must be performed to get the spectrum evenly sampled. Zero-filling technique must be applied before the interpolation to avoid shoulders around the peaks at greater depths. In both methods, the final image is formed by measuring several adjacent A-scans and then combining them together in software like Matlab, Paraview, Amira or Avizo for tomogram reconstruction or 3D volumetric rendering.

Spectral domain system offers increased sensitivity and speed over time domain systems since it measures all the photons returning from the sample simultaneously. In addition, numerical dispersion compensation can be performed instead of using extra optics in the reference arm. Dispersion compensation is crucial when using super broadband light sources like supercontinuum sources. Dispersion decreases the resolution as a function of depth dramatically even with a thin samples (in the order of tens of micrometers).

### Systems and Apparatuses

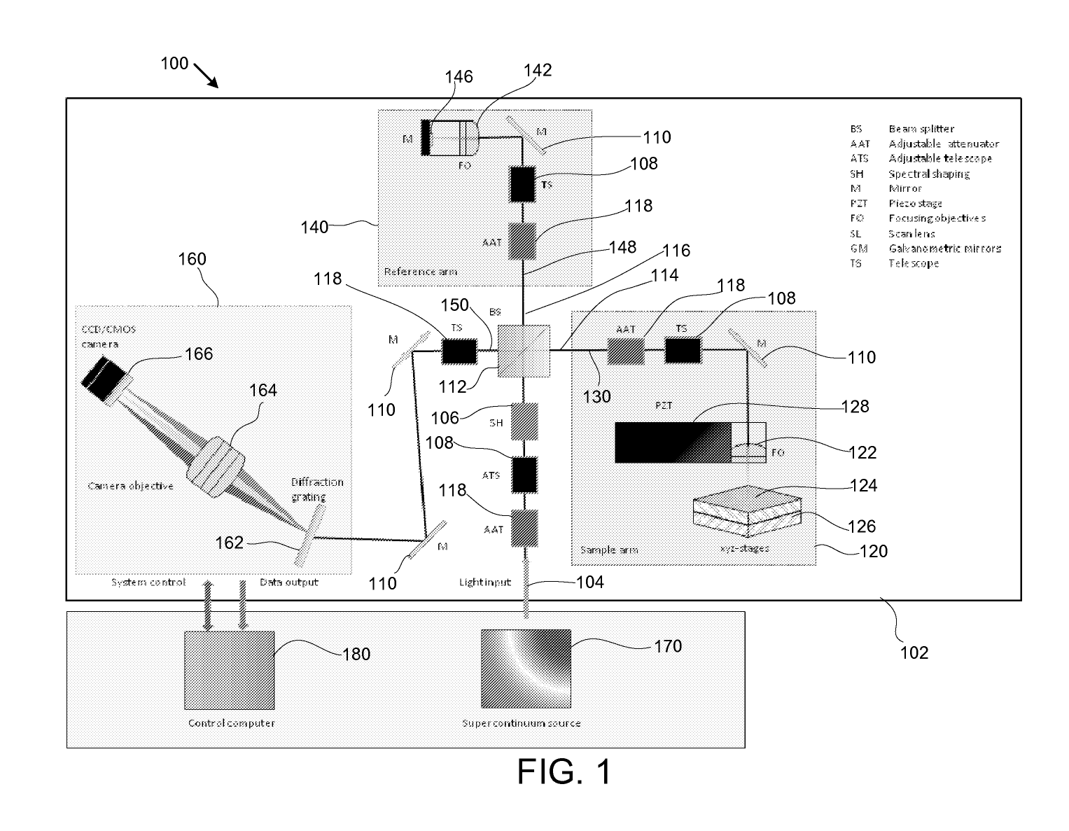

FIG. 1 illustrates one embodiment of a system 100 for submicron resolution spectral-domain optical coherence tomography (OCT). In one embodiment, the system 100 may offer a spatial resolution below 1 μm. The system 100 may comprise a light source 170, an apparatus 102, and a controller 180. The apparatus 102 may comprise a sample arm 120, a reference arm 140 and a spectrometer 160.

The light source 170 may be a supercontinuum laser source, superluminescent diode (SLD) source, or other kind of laser source. The light source 170 may be configured to generate a light input 104. The light input 104 may have low coherence. The light input 104 may be white light comprising a plurality of components with different wavelengths. In one embodiment, the light input 104 have wavelengths only within the range of 400-1000 nm. In another embodiment, the light input 104 comprises a first light component having wavelengths within the range of 400-1000 nm and a second light component having wavelengths outside the range of 400-1000 nm.

In one embodiment, the apparatus 102 may be aggregated into a unitary piece. The apparatus 102 may be configured to be detachable from the light source 170 and the controller 180. For example, the apparatus 102 may be aggregated in a ready-to-use box, and a user can connect a user provided light source and controller to the apparatus 102.

In one embodiment, the apparatus 102 may be configured to receive a light input 104 from the light source 170. The apparatus 102 may further comprise a spectrum shaping device 106 configured to filter out undesired light components of the light input 104 and generate a light beam with light components having wavelengths in a desired range. For example, when the light input 104 comprises a first component having wavelengths within the range of 400-1000 nm and a second component having wavelengths outside the range of 400-1000 nm, the spectrum shaping device 106 may filter out the second component and keep the first component of the light input to generate a light beam having wavelengths only within the range of 400-1000 nm.

In one embodiment, the apparatus 102 comprises one or more magnifying devices 108 configured to adjust a diameter of a light input. The magnifying device 108 may increase or decrease the diameter of a light input. In certain embodiments, the magnifying device 108 is a telescope. In some embodiments, apparatus 102 may comprise one or more mechanisms to adjust intensity of a light beam. Intensity of a light beam can be adjusted by passing the light beam through one or more attenuators, such as neutral density filters (ND-filters), polarizer-analyzer-combinations, or the like, or by partially reflecting the light beam from an optical surface. In the depicted embodiment, apparatus 102 comprises one or more attenuators 118 configured to adjust an intensity of a light beams, such as light input 104. Attenuators 118 may be adjustable such that a light output of attenuators 118 has a target light intensity. Apparatus 102 may further comprise a beam splitter 112 configured to split a light input into two or more light beams. For example, beam splitter 112 can split a light input into a first light beam 114 and a second light beam 116. It should be understood that the order of the spectrum shaping device 106, magnifying device 108, attenuators 118, and/or other components of the apparatus 102 may be exchangeable.

In one embodiment, the sample arm 120 of apparatus 102 may be configured to receive a first light beam 114. The first light beam 114 is white light comprising a plurality of light components with different wavelengths. The first light beam may have wavelengths only within the range of 1000 nanometers (nm) or less. In one embodiment, the first light beam 114 may have wavelengths only within the range of 400-1000 nm.

The sample arm 120 may comprise an attenuator 118 configured to adjust the intensity of the first light beam 114. The sample arm 120 may further comprise one or more minors 110 configured to adjust the direction of the first light beam 114. The sample arm 120 may also comprise a focusing device 122 configured to adjust the diameter of the first light beam 114. The focusing device 122 may further be configured to adjust a direction of the first light beam 114 such that the beam reaches a sample 124. The focusing device 122 may be configured to be movable, for example, along a longitudinal axis of the first light beam 114, or of the first light beam 114 with a direction adjusted by the mirror 110. For example, the focusing device 122 may be coupled to a support stage 128, which is configured to be movable.

In one embodiment, the sample arm 120 may comprise a sample stage 126 configured to receive a sample 124. The sample stage 126 may be configured to be movable. For example, sample stage may be movable along a longitudinal axis of the first light beam 114, or of the first light beam 114 with a direction adjusted by the mirror 110. Sample stage 126 may be also configured to be movable in a direction substantially perpendicular to a longitudinal axis of the first light beam 114, or of the first light beam 114 with a direction adjusted by the mirror 110. The first light beam 114 may be reflected by the sample 126 in the sample arm 120, which outputs a sample output beam 130. According to certain aspects of the present disclosure, it should be understood that all optical devices, such as minors, focusing devices, beam splitters, beam attenuators, magnifying objects, or the like, are bidirectional.

In one embodiment, the reference arm 140 of apparatus 102 may be configured to receive a second light beam 116. The second light beam 116 is white light comprising a plurality of light components with different wavelengths. The second light beam may have wavelengths only within the range of 1000 nanometers (nm) or less. In one embodiment, the second light beam 116 may have wavelengths only within the range of 400-1000 nm. The focusing device 142 and reflecting device 146 may be configured to be movable together along the longitudinal axis of the second light beam 116, with a direction adjusted by one or more mirrors 110.

In one embodiment, the reference arm 140 may comprise an attenuator 118 configured to adjust the intensity of the second light beam 116. The reference arm 140 may further comprise one or more minors 110 configured to adjust a direction of the second light beam 116. The reference arm 140 may also comprise a focusing device 142 configured to adjust a diameter of the second light beam 116. The focusing device 142 may be fixed or movable. The reference arm 140 may further comprise a reflecting device 146 configured to adjust a direction of the second light beam 116. The reference arm 140 output a reference output beam 148.

The sample output beam 130 and the reference output beam 148 are combined to generate a light output 150. In one embodiment, the sample output beam 130 and the reference output beam 148 are combined at splitter 112. In another embodiment, the sample output beam 130 and the reference output beam 148 may be combined at a light combiner. One of ordinary skill in the art will recognize other methods and/or devices to combine the sample output beam 130 and the reference output beam 148 are combined. In one embodiment, the attenuators 118 and focusing devices 108 are configured such that the sample output beam 130 and the reference output beam 148 have substantially similar light intensities. The light output 150 may be directed into the spectrometer 160, e.g. by one or more mirrors 110.

In one embodiment, the spectrometer 160 comprises a diffraction grating 162 configured to split the light output 150 into a plurality of light components having different wavelengths. In one embodiment, the spectrometer 160 further comprises a recording device 166 configured to record the plurality of light components as electrical signals. The recording device 166 may be a camera, such as a CCD camera, a CMOS camera, or the like. The spectrometer 160 may further comprise a camera objective 164 configured to adjust the direction of the plurality of light components output by the diffraction grating 162. In one embodiment, the camera objective 164 may comprise a plurality of convex and/or concave lens arraigned in a certain order.

In one embodiment, the controller 180 is configured to receive and/or store the electrical signals from the recording device 166. The controller 180 may be further configured to control the recording of the light output 150, e.g., by the recording device 166, as electrical signals, movements of the sample stage 126 and/or focusing device 122, focusing device 124, and/or reflecting device 146, direction of the mirrors 110, the attenuators 108, the spectrum shaping device, or the like.

The controller 180 may be a general-purpose computer, a tablet computer, or the like. The controller 180 may further comprise a processor configured to perform certain operations on the electrical signals received from the apparatus 102. For example, the controller may amplify, quantize, and/or filter the electrical signals, and/or perform (inverse) Fourier transform on the electrical signals.

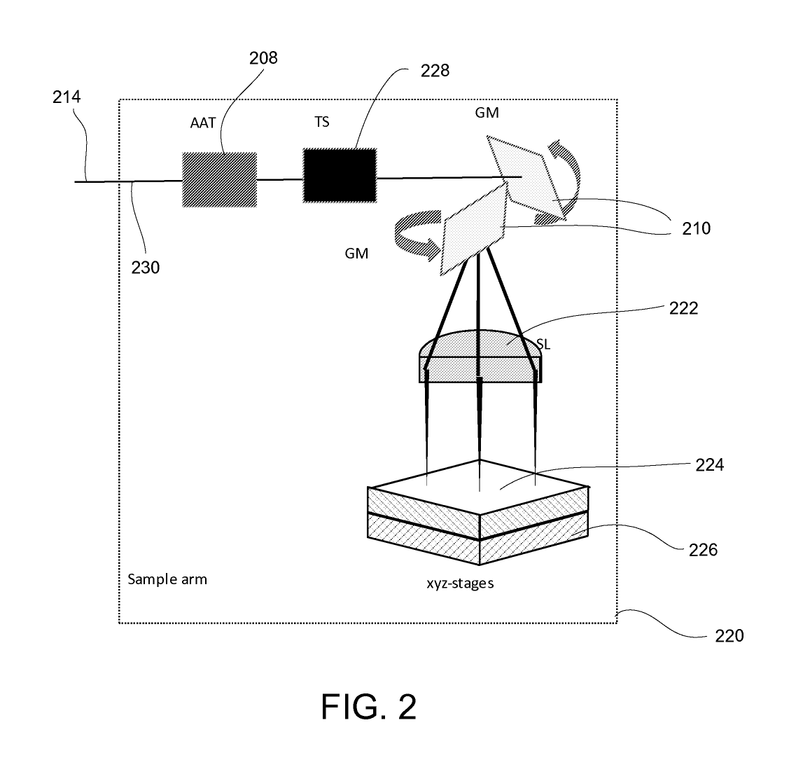

FIG. 2 illustrates one embodiment of a sample arm 220 for a system for submicron resolution spectral-domain OCT. The sample arm 220 is configured to receive a light beam 214 and output a sample output beam 230. The sample arm 220 may comprise a scanning lens 222 configured to adjust a direction and/or diameter of a light beam 214 such that the light beam 214 can reach a sample 224, which may be hosted by a sample stage 226. The scanning lens 222 may be fixed, or movable. In one embodiment, the sample arm 220 comprises one or more Galvanometric minors 210 configured to adjust direction of a light beam 214. For example, the Galvanometric minors 210 may direct a light beam 214 to a certain direction so that the light beam can engage a target area of the scanning lens 222. The Galvanometric mirrors 210 is further configured to movable and/or rotatable, such that a light beam 214 is directed to a target direction.

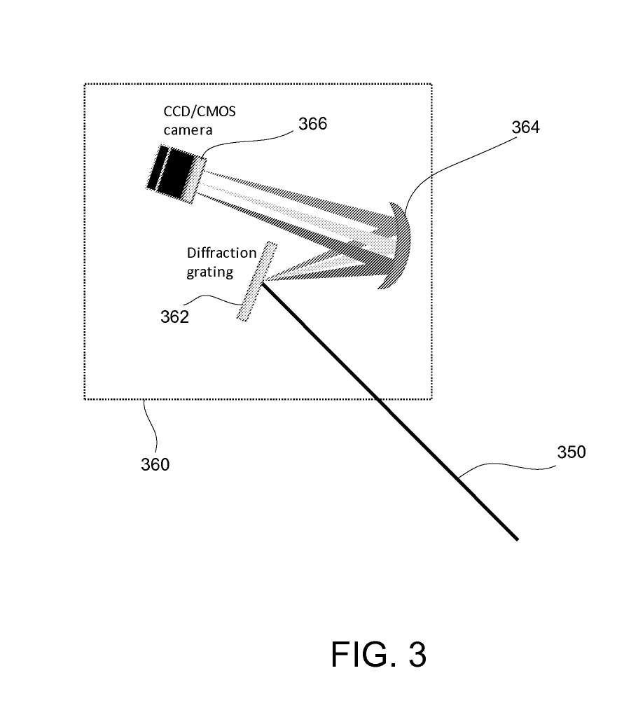

FIG. 3 illustrates one embodiment of a spectrometer 360 for a system for submicron resolution spectral-domain OCT. The spectrometer 360 is configured to receive a light beam 350, and record the light as electrical signals. In one embodiment, the spectrometer 360 may comprise a diffracting grating 362 and/or a recording device 366, such as those described in FIG. 1. The spectrometer 360 may further comprise a spherical mirror 364 configured adjust the directions of a plurality of light components output by the diffraction grating 362.

All of the methods disclosed and claimed herein can be made and executed without undue experimentation in light of the present disclosure. While the apparatus and methods of this invention have been described in terms of preferred embodiments, it will be apparent to those of skill in the art that variations may be applied to the methods and in the steps or in the sequence of steps of the method described herein without departing from the concept, spirit and scope of the invention. In addition, modifications may be made to the disclosed apparatus and components may be eliminated or substituted for the components described herein where the same or similar results would be achieved. All such similar substitutes and modifications apparent to those skilled in the art are deemed to be within the spirit, scope, and concept of the invention as defined by the appended claims.

What is claimed is:

1. An apparatus for optical coherence tomography, comprising:
a sample arm configured to direct a first light beam to a sample and output a sample output beam, the first light beam having wavelengths within a range of 1000 nanometers or less;
a reference arm configured to receive a second light beam and output a reference output beam, the second light beam having wavelengths within the range of 1000 nanometers or less;
a mechanism to combine the sample output beam and the reference output beam to generate a light output; and
a spectrometer configured to convert the light output into electrical signals.

2. The apparatus of claim 1, aggregated into a unitary piece.

3. The apparatus of claim 1, the first light beam and the second light beam having wavelengths within a range of 400-1000 nanometers.

4. The apparatus of claim 1, further comprising a beam splitter configured to split a light input into the first light beam and the second light beam.

5. The apparatus of claim 4, the light input being generated by a supercontinuum source.

6. The apparatus of claim 4, the light input comprising a first light component having wavelengths within a range of 400-1000 nanometers and a second light component having wavelengths outside the range of 400-1000 nanometers.

7. The apparatus of claim 6, further comprising a spectrum shaping device configured to generate a light beam from the light input, the light beam having wavelengths within the range of 400-1000 nanometers.

8. The apparatus of claim 4, wavelengths of the light input being within a range of 400-1000 nanometers.

9. The apparatus of claim 1, the sample arm comprising a focusing device configured to adjust a diameter of the first light beam before the first light beam reaches the sample.

10. The apparatus of claim 9, the focusing device configured to be movable along a longitudinal axis of the first light beam.

11. The apparatus of claim 1, the sample arm comprising a sample stage configured to receive the sample, the sample stage configured to be movable.

12. The apparatus of claim 11, the sample stage configured to be movable along a longitudinal axis of the first light beam.

13. The apparatus of claim 11, the sample stage configured to be movable in a direction substantially perpendicular to a longitudinal axis of the first light beam.

14. The apparatus of claim 1, the spectrometer comprising a diffraction grating configured to split the light output into a plurality of light components having different wavelengths.

15. The apparatus of claim 14, the spectrometer further comprising a recording device configured to record the plurality of light components as electrical signals.

16. A system for optical coherence tomography comprising:
a light source configured to output a light input;
an apparatus comprising:
a sample arm configured to direct a first light beam to a sample and output a sample output beam, the first light beam generated from the light input and having wavelengths within a range of 1000 nanometers or less;
a reference arm configured to receive a second light beam and output a reference output beam, the second light beam generated from the light input and having wavelengths within the range of 1000 nanometers or less;
a mechanism to combine the sample output beam and the reference output beam to generate a light output; and
a spectrometer configured to convert the light output into electrical signals; and
a controller coupled to the apparatus and configured to receive the electrical signals.

17. The system of claim 16, the apparatus aggregated into a unitary piece.

18. The system of claim 17, the apparatus detachable from the light source and controller.

19. The system of claim 16, the first light beam and the second light beam having wavelengths within a range of 400-1000 nanometers.

20. The system of claim 16, further comprising a beam splitter configured to split the light input into the first light beam and the second light beam.

21. The system of claim 16, the light source being a supercontinuum source.

22. The system of claim 16, the light input comprising a first light component having wavelengths within a range of 400-1000 nanometers and a second light component having wavelengths outside the range of 400-1000 nanometers.

23. The system of claim 22, further comprising a spectrum shaping device configured to generate a light beam from the light input, the light beam having wavelengths within the range of 400-1000 nanometers.

24. The system of claim 16, wavelengths of the light input being within a range of 400-1000 nanometers.

25. The system of claim 16, the sample arm comprising a focusing device configured to adjust a diameter of the first light beam before the first light beam reaches the sample.

26. The system of claim 25, the focusing device configured to be movable along a longitudinal axis of the first light beam.

27. The system of claim 26, the controller further configured to control a movement of the focusing device.

28. The system of claim 16, the sample arm comprising a sample stage configured to receive the sample, the sample stage configured to be movable.

29. The system of claim 16, the sample stage configured to be movable along a longitudinal axis of the first light beam.

30. The system of claim 16, the sample stage configured to be movable in a direction substantially perpendicular to a longitudinal axis of the first light beam.

31. The system of claim 16, the controller further configured to control a movement of the stage.

32. The system of claim 16, the spectrometer comprising a diffraction grating configured to splitting the light output into a plurality of light components having different wavelengths.

33. The system of claim 32, the spectrometer further comprising a recording device configured to record the plurality of light components as electrical signals.

34. The system of claim 33, the controller further configured to control the recording device.

35. The system of claim 33, the recording device comprising a camera.

36. The apparatus of claim 1, in which the reference arm comprises a reflecting device configured to adjust a diameter of the second light beam.

37. The apparatus of claim 36, in which the reference arm is configured to be moveable along a longitudinal axis of the second light beam.

38. The apparatus of claim 37, in which the reference arm further comprises a focusing device configured to be movable with the reflecting device.

39. The apparatus of claim 36, in which the reference arm comprises at least one mirror configured to adjust a direction of the second light beam.
